(19) United States
(12) Patent Application Publication
(10) Pub. No.: US 2024/0112080 A1
(43) Pub. Date: Apr. 4, 2024

(54) METHODS AND COMPUTER DEVICES FOR SIGNAL MODULATION

(71) Applicant: Deep Labs, Inc., San Mateo, CA (US)

(72) Inventors: Theodore HARRIS, San Francisco, CA (US); Scott EDINGTON, Arlington, VA (US); Yue LI, Sunnyvale, CA (US); Simon Robert Olov NILSSON, Seattle, WA (US)

(73) Assignee: Deep Labs, Inc., San Mateo, CA (US)

(21) Appl. No.: 18/151,456

(22) Filed: Jan. 8, 2023

Related U.S. Application Data
(60) Provisional application No. 63/411,886, filed on Sep. 30, 2022.

(51) Int. Cl. G06N 20/00

(52) U.S. Cl. CPC G06N 20/00

(57) ABSTRACT

A method for signal modulation includes: receiving network signals from a plurality of participants; analyzing the received network signals to detect latent signals; processing the network signals based on one or more external event data; processing the network signals to exclude sensitive data in the network signals and the latent signals; and encapsulating pan-network signals based on the processed network signals.

### CROSS REFERENCE TO RELATED APPLICATIONS

This application claims the benefit of priority to U.S. Provisional Application No. 63/411,886 filed on Sep. 30, 2022, which is incorporated herein by reference in its entirety.

### TECHNICAL FIELD

The present disclosure generally relates to signal modulation for machine learning applications. More specifically, and without limitation, the present disclosure relates to systems and methods for automated pan-network signal modulation for information exclusion and discovery.

### BACKGROUND

Machine learning (ML) and artificial intelligence (AI) systems can be used in various applications to provide streamlined user experiences on digital and cloud-based platforms. AI/ML systems may enable the use of large amounts of data stored in databases, data gathered in knowledge bases, peer information, or data that is otherwise available, such as environmental information. AI/ML systems can quickly analyze massive amounts of data and can provide a user with useful feedback that may guide the user to reach desirable outcomes.

While sharing data across participants on a cloud-based AI/ML platform may improve the platform performance and security, direct data sharing may be restricted in some jurisdictions due to legal and privacy concerns. Parties using the cloud services may also refuse to reveal data associated with sensitive information or share data given their market positions. These barriers prevent successful data sharing, which is critical to the network security and the user experience.

### SUMMARY

In accordance with some embodiments, a method for signal modulation is provided. The method includes: receiving network signals from a plurality of participants; analyzing the received network signals to detect latent signals; processing the network signals based on one or more external event data; processing the network signals to exclude sensitive data in the network signals and the latent signals; and encapsulating pan-network signals based on the processed network signals.

In accordance with some embodiments, a computing device is provided. The computing device includes: a memory configured to store computer-executable instructions; and one or more processors coupled to the memory and configured to execute the computer-executable instructions to perform: receiving network signals from a plurality of participants; analyzing the received network signals to detect latent signals; processing the network signals based on one or more external event data; processing the network signals to exclude sensitive data in the network signals and the latent signals; and encapsulating pan-network signals based on the processed network signals.

In accordance with some embodiments, a non-transitory computer-readable storage medium is provided. The non-transitory computer-readable storage medium stores a set of instructions that are executable by one or more processors of a device to cause the device to perform the above method for signal modulation.

It is to be understood that both the foregoing general description and the following detailed description are exemplary and explanatory only and are not restrictive of the disclosed embodiments, as may be claimed.

### BRIEF DESCRIPTION OF DRAWINGS

FIG. 1 is a diagram of an exemplary server for performing a method for signal modulation, consistent with some embodiments of the present disclosure.

FIG. 2 is a diagram of an exemplary user device, consistent with some embodiments of the present disclosure.

FIG. 3 is a block diagram of a platform built by using the server in FIG. 1 and the user device in FIG. 2, consistent with embodiments of the present disclosure.

FIG. 4 is a block diagram illustrating details of an Automatic Pan-Network Signal Modulator (APNSM) unit of the platform in FIG. 3, consistent with embodiments of the present disclosure.

FIG. 5 is a flowchart diagram of an exemplary computer-implemented method for signal modulation, consistent with some embodiments of the present disclosure.

FIG. 6 is a flowchart diagram of another exemplary computer-implemented method for signal modulation, consistent with some embodiments of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to subject matter described herein.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C. Expressions such as “at least one of” do not necessarily modify an entirety of a following list and do not necessarily modify each member of the list, such that “at least one of A, B, and C” should be understood as including only one of A, only one of B, only one of C, or any combination of A, B, and C. The phrase “one of A and B” or “any one of A and B” shall be interpreted in the broadest sense to include one of A, or one of B.

In some embodiments, a variety of pan-network signals may be used to enrich downstream event processing when the data is shared across participants. Examples of pan-network signals in various applications may include fraud or return rates summarized at a combination of inputs (e.g., merchant, time of day, amount, etc.) to correct segment fraud without identifying the cardholder, payment volumes summarized at a merchant and geographic level, a network linkage between the location of merchants based on the purchase behavior of cardholders, network traffic information summarized by the time of day and geolocation information, Natural Language Processing (NLP) analysis of data, such as complaints, reviews, etc., an IP address that exhibits behavior anomalies (e.g., potential denial of service attacks), a number of inbound job applications, a change in hours of a worker's logins, a user's log in behavior, anonymized loan outcome data, etc.

For example, in an AI-based application for consumer complaints and reviews, a platform can detect trends or patterns using participant datasets and open datasets to identify subtle trends in users' reviews and complaints that could be indicative of frauds, systemic issues, emerging issue, etc. In another example, a platform can detect new fraud motifs using news events information of fraudulent behaviors. The fraudulent behaviors may include new fraud modes, new fraud medias, and/or new fraud targeting groups, but the present disclosure is not limited thereto. In yet another example, a platform may be configured to monitor pan-network data continuously to uncover signals indicative of zero-day exploits being executed.

By sharing pan-network risk signals, such as security breach patterns to payment fraud motifs, across the network, fraudulent activity can be mitigated and reduced. In addition, by sharing patterns in purchases, complaints, and/or other financial-related activities, AI-based applications may provide more sophisticated, seamless, powerful interactions with participants (e.g., customers) and offer a hyper-personalized experience.

However, direct data sharing may be restricted in some jurisdictions due to legal and privacy concerns. Parties using the cloud services may also refuse to reveal latent signals associated with sensitive information or share data given their market positions. These barriers prevent successful information sharing that is critical to securing the network and enhancing the user experience.

In various embodiments of the present disclosure, an Automatic Pan-Network Signal Modulator (APNSM) is designed to perform a method for signal modulation and identify key network signals across participants within a cloud or network infrastructure automatically. The identified signals can be tuned according to specific participant needs, and sensitive data can be modulated or restricted. By performing the method for signal modulation to remove sensitive data, the modulator is configured to enable pan-network signals for all participants with individually tuned feeds, while sensitive data of each specific participant is protected. In some embodiments, participants may also adjust AI/ML-based platforms to their needs by providing human-derived or interactive feedback data. In some embodiments, dynamic external events from the pan-network, such as major news events, can also be used for tuning the pan-network signals automatically.

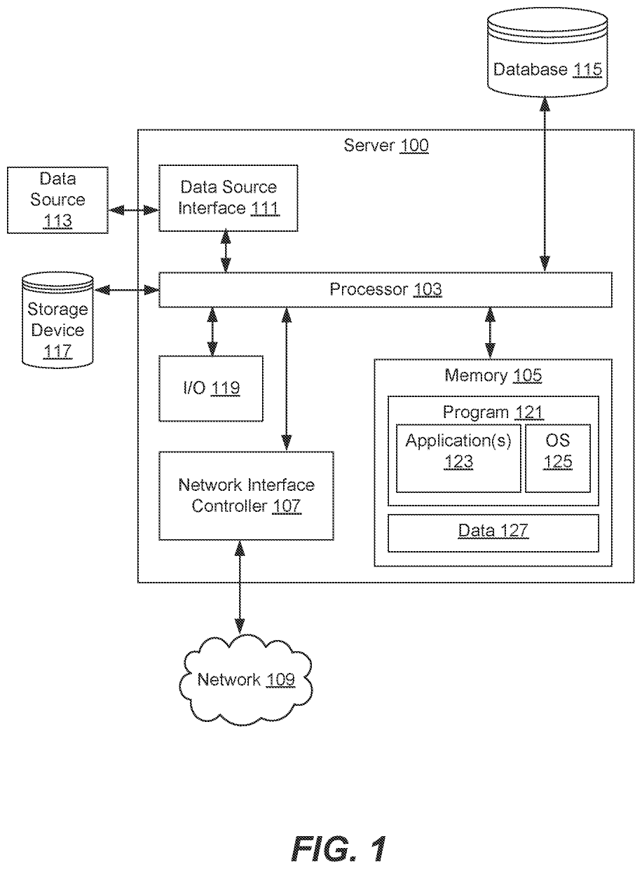

FIG. 1 illustrates a server 100 for implementing an APNSM for performing the method for signal modulation, consistent with embodiments of the present disclosure. As shown in FIG. 1, the server 100 may include a processor 103, a memory 105, and a network interface controller 107. The processor 103, which may be a single-core processor or a multi-core processor, includes at least one processor configured to execute one or more programs 121, applications, processes, methods, or other software to perform disclosed embodiments of the present disclosure. In some embodiments, the processor 103 may include one or more circuits, microchips, microcontrollers, microprocessors, central processing unit, graphics processing unit, digital signal processor, or other suitable circuits for executing instructions stored in the memory 105, but the present disclosure is not limited thereto. It is understood that other types of processor arrangements could be implemented.

As shown in FIG. 1, the processor 103 is configured to communicate with the memory 105. The memory 105 may include the one or more programs 121 and data 127. In some embodiments, the memory 105 may include any area where the processor 103 or a computer stores the data 127. A non-limiting example of the memory 105 may include semiconductor memory, which may either be volatile or non-volatile. For example, the non-volatile memory may include flash memory, ROM, PROM, EPROM, and EEPROM memory. The volatile memory may include dynamic random-access memory (DRAM) and static random-access memory (SRAM), but the present disclosure is not limited thereto.

The program 121 stored in the memory 105 may refer to a sequence of instructions in any programming language that the processor 103 may execute or interpret. Non-limiting examples of program 121 may include an operating system (OS) 125, web browsers, office suites, or video games. The program 121 may include at least one of server application(s) 123 and the OS 125. In some embodiments, the server application 123 may refer to software that provides functionality for other program(s) 121 or devices. Non-limiting examples of provided functionality may include facilities for creating web applications and a server environment to run them. Non-limiting examples of server application 123 may include a web server, a server for static web pages and media, a server for implementing business logic, a server for mobile applications, a server for desktop applications, a server for integration with a different database, and any other similar server type. For example, the server application 123 may include a web server connector, a computer programming language, runtime libraries, database connectors, or administration code. The operating system 125 may refer to software that manages hardware, software resources, and provides services for programs 121. The operating system 125 may load the program 121 into the memory 105 and start a process. Accordingly, the processor 103 may perform this process by fetching, decoding, and executing each machine instruction.

As shown in FIG. 1, the processor 103 may communicate with the network interface controller 107. The network interface controller 107 may refer to hardware that connects a computer or the processor 103 to a network 109. In some embodiments, the network interface controller may be a network adapter, a local area network (LAN) card, a physical network interface card, an ethernet controller, an ethernet adapter, a network controller, or a connection card. The network interface controller 107 may be connected to the network 109 wirelessly, by wire, by USB, or by fiber optics. The processor 103 may communicate with an external or internal database 115, which may function as a repository for a collection of data 127. The database 115 may include relational databases, NoSQL databases, cloud databases, columnar databases, wide column databases, object-oriented databases, key-value databases, hierarchical databases, document databases, graph databases, and other similar databases. The processor 103 may communicate with a storage device 117. The storage device 117 may refer to any type of computing hardware that is used for storing, porting, or extracting data files and objects. For example, the storage device 117 may include random access memory (RAM), read-only memory (ROM), floppy disks, and hard disks.

In addition, the processor 103 may communicate with a data source interface 111 configured to communicate with a data source 113. In some embodiments, the data source interface 111 may refer to a shared boundary across which two or more separate components of a computer system exchange information. For example, the data source interface 111 may include the processor 103 exchanging information with data source 113. The data source 113 may refer to a location where the data 127 originates from. The processor 103 may communicate with an input or output (1/O) interface 119 for transferring the data 127 between the processor 103 and an external peripheral device, such as sending the data 127 from the processor 103 to the peripheral device, or sending data from the peripheral device to the processor 103.

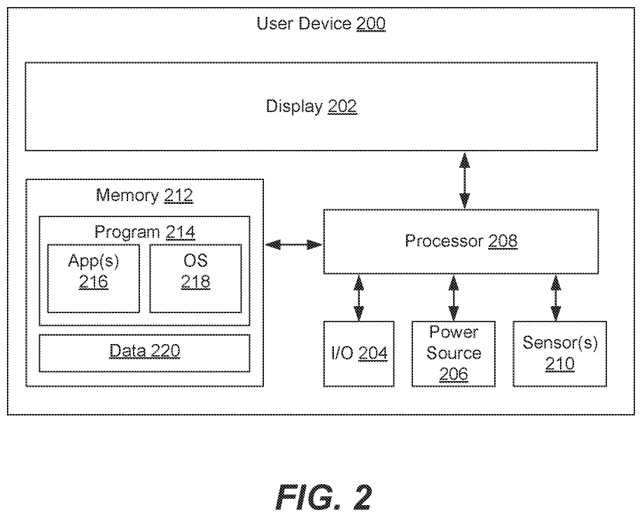

FIG. 2 illustrates a user device 200, consistent with embodiments of the present disclosure. The user device 200 shown in FIG. 2 may refer to any device, instrument, machine, equipment, or software that is capable of intercepting, transmitting, acquiring, decrypting, or receiving any sign, signal, writing, image, sound, or data in whole or in part. For example, the user device 200 may be a smartphone, a tablet, a Wi-Fi device, a network card, a modem, an infrared device, a Bluetooth device, a laptop, a cell phone, a computer, an intercom, etc. In the embodiments of FIG. 2, the user device 200 may include a display 202, an input/output unit 204, a power source 206, one or more processors 208, one or more sensors 210, and a memory 212 storing program(s) 214 (e.g., device application(s) 216 and OS 218) and data 220. The components and units in the user device 200 may be coupled to each other to perform their respective functions accordingly.

As shown in FIG. 2, the display 202 may be an output surface and projecting mechanism that may show text, videos, or graphics. For example, the display 202 may include a cathode ray tube (CRT), liquid crystal display (LCD), light-emitting diode, gas plasma, or other image projection technology.

The power source 206 may refer to hardware that supplies power to the user device 200. In some embodiments, the power source 206 includes a battery. The battery may be a lithium-ion battery. Additionally, or alternatively, the power source 206 may be external to the user device 200 to supply power to the user device 200. The one or more sensors 210 may include one or more image sensors, one or more motion sensors, one or more positioning sensors, one or more temperature sensors, one or more contact sensors, one or more proximity sensors, one or more eye tracking sensors, one or more electrical impedance sensors, or any other technology capable of sensing or measuring. For example, the image sensor may capture images or videos of a user or an environment. The motion sensor may be an accelerometer, a gyroscope, and a magnetometer. The positioning sensor may be a GPS, an outdoor positioning sensor, or an indoor positioning sensor. For example, the temperature sensor may measure the temperature of at least part of the environment or user. For example, the electrical impedance sensor may measure the electrical impedance of the user. The eye-tracking sensor may include a gaze detector, optical trackers, electric potential trackers, video-based eye-trackers, infrared/near infrared sensors, passive light sensors, or other similar sensors. The program 214 stored in the memory 212 may include one or more device applications 216, which may be software installed or used on the user device 200, and an OS 218.

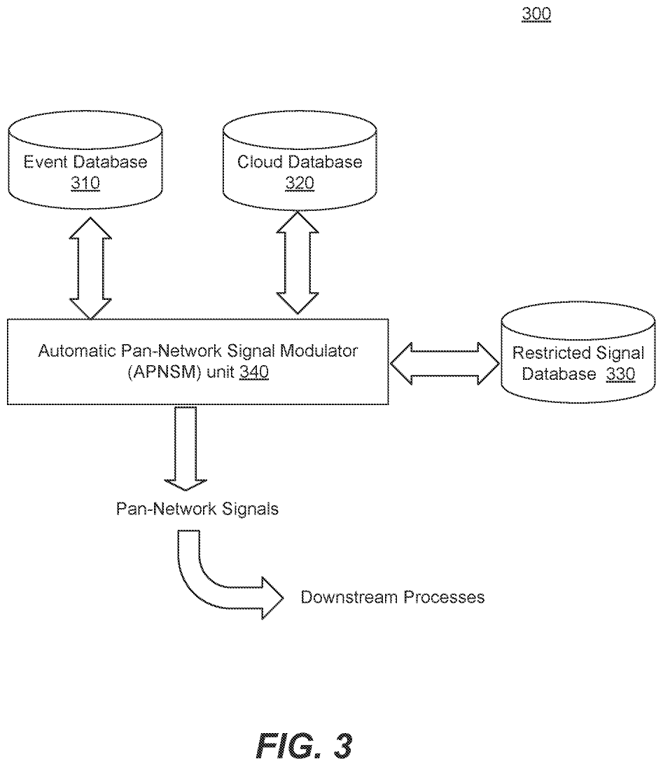

FIG. 3 is a block diagram of a platform 300 built by using the server 100 in FIG. 1 and the user device 200 in FIG. 2, consistent with embodiments of the present disclosure. In particular, the server 100 shown in FIG. 1 can communicate with the user device 200 in FIG. 2 and execute corresponding computer instructions to provide the platform 300 for running one or more AI-based applications across different use cases.

As shown in FIG. 3, the platform 300 may include an event database 310, a cloud database 320, a restricted signal database 330, and an APNSM unit 340, but the present disclosure is not limited thereto. In some embodiments, the event database 310 may be configured to store event data associated with one or more participants of the cloud services deployed on the cloud or network infrastructure. The cloud database 320 may be configured to store data associated with the configuration, global insights, or other data to be used by the APNSM unit 340 of the platform 300. The restricted signal database 330 may be configured to store restricted participant signals or data associated with each participant of the cloud services.

The APNSM unit 340 may be configured to enable the participants of the cloud services to share signals derived from participants' data without violating confidentiality agreements and ensure that market differentiating signals or latent signals are not shared. In some embodiments, these signals and latent structures are automatically excluded by the APNSM unit 340, and the APNSM unit 340 may store the restricted data associated with each participant in the restricted signal database 330 accordingly. In some embodiments, the APNSM unit 340 may also function as a data discovery search engine for participants to identify new signals and/or partnerships.

After the processing of the APNSM unit 340, the platform 300 may provide the encapsulated and tuned pan-network signals for downstream AI/ML-based processing. As discussed above, the platform 300 may be used in different use cases. In some use cases, the platform 300 may detect trends in reviews and complaints. In some other use cases, the platform 300 may detect new fraud motifs. In yet some other use cases, the platform 300 may detect zero-day exploits by monitoring data continuously.

In addition, in some use cases, the platform 300 may automatically detect a combination of data attributes providing a latent signal correlated with predetermined sensitive data (e.g., data that reveals a person's race or ethnic origin, political opinions, religious or philosophical beliefs, health information, etc.). In some embodiments, the platform 300 may selectivity enable or disable a bias modulation. In particular, the bias modulation may be disabled or limited based on different conditions such as local regulations, legal requirements, and/or platform agreements.

Moreover, in some embodiments, the platform 300 can be configured to perform signal discovery. For example, the platform 300 may enable an automated search and discovery of signals correlated with a set of problems (e.g., a supervised model performance) or signals enabling better data separation (e.g., clustering). In some embodiments, the platform 300 can be configured to scan pan-network signals automatically to detect whether an erroneous or weakening signal modulation occurs. For example, the platform 300 may analyze whether there are signals providing no or limited value across known labels, or signals degrading over time to identify potential erroneous or weakening signal modulation.

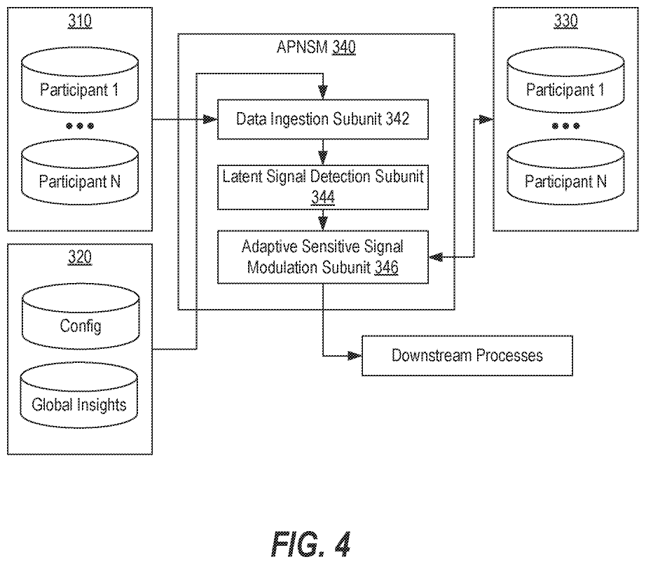

FIG. 4 is a block diagram illustrating details of the APNSM unit 340, consistent with embodiments of the present disclosure. As shown in FIG. 4, the APNSM unit 340 may include a data ingestion subunit 342, a latent signal detection subunit 344, and an adaptive sensitive signal modulation subunit 346.

The data ingestion subunit 342 enables flexible and fast data ingestion, normalization, and featurization. In some embodiments, transformation rules applied in the data ingestion subunit 342 can be expressed in metadata to enable quick reuse. When a new data source is added, the new data source can be analyzed and matched again with prior signals to select the most similar metadata to use. The data ingestion subunit 342 may be configured to receive event data associated with different participants of the cloud services from the event database 310, and data associated with the configuration or global insights of the cloud services from the cloud database 320. In some embodiments, the data ingestion subunit 342 may process unstructured data gathered from multiple sources in various formats and operationalize the gathered data. For example, types of input data may include image data, unstructured data, graph data, categorical data, contentious wavelets, but the present disclosure is not limited thereto. For image data, the output of the data ingestion subunit 342 may include neural network (NN) Tagging data and/or metadata extraction data. For unstructured data, the output of the data ingestion subunit 342 may include NLP data and/or Bidirectional Encoder Representations from Transformers (BERT) data, For graph data, the output of the data ingestion subunit 342 may include nodes and edges associated with the graph data. For categorical data, the output of the data ingestion subunit 342 may include one-hot encoding data and/or index look-up information. For continuous wavelets, the output of the data ingestion subunit 342 may include wavelets, fuzzy features, and/or binning information. The data ingestion subunit 342 may also receive human-derived or interactive feedback data from one or more participants for tuning the network signals. In some embodiments, an automated quality control (QC) may perform the quality control by generating a series of metrics that are used for both quality control and model selection. Exemplary key metrics may include data such as Kolmogorov-Smirnov test data, Shapiro-Wilk data, basic statistic data (e.g., min value, max value, mean value, STD value, median value, etc.), Chi-square goodness-of-fit data, etc.

By the data ingestion and processing performed by the data ingestion subunit 342, the APNSM unit 340 is able to ingest information from a wide variety of sources, including data sources that have not been prepared or processed specifically for use with neural network systems. Accordingly, the APNSM unit 340 may provide more flexibilities and allow the neural network system to process the data more efficiently and accurately regardless of the format of the data sources, which enables the neural network system to process and react to information from various indiscriminate and random sources. The data ingestion process performed by the data ingestion subunit 342 also involves wavelet processing, which is described in more detail in U.S. Publication No. 2021/0073652, U.S. Publication No. 2021/0110387, and U.S. Pat. No. 11,182,675, contents of which are hereby incorporated by reference in their entirety.

The latent signal detection subunit 344 may be configured to provide ongoing analysis of the processed data being shared, and detect signals and latent signals within the data accordingly. For example, the latent signal detection subunit 344 may identify cross-network signals, patterns, or motifs based in the received data. In some embodiments, the latent signal detection subunit 344 includes an engine designed to enable rapid or automatic processing of new signals and is configured to determine if a participant's sensitive data can be derived with great signal library when the participant's data is included. In some embodiments, the concern is whether the data proved by the participant is exposing the participant and not whether the signal library has the ability to detect the sensitive signals.

For example, for new signals, the latent signal detection subunit 344 may perform an initialization process and then an automated parameter search and tuning process. In the initialization process, the latent signal detection subunit 344 first uses signal metrics from prior models signals to define a data space. Then, an indexer is fitted to the defined data space. For each prior model, the latent signal detection subunit 344 builds a series of the suboptimal models by adjusting the optimum parameter values positively and negative (e.g., a series of [1, 2, 3, 4, 5, 6, 7, 8, 9] is used for the optimum parameter value of 5).

Then, the latent signal detection subunit 344 generates fitness metrics for the sub-optimal models, and builds XGBoost (XGB) models for each Uniform Manifold Approximation and Projection (UMAP) and Hierarchical Density-Based Spatial Clustering of Applications with Noise (HDBScan) parameter for predicting optimal parameter values based on the generated metrics.

In the automated parameter search and tuning process for new signals, the latent signal detection subunit 344 first uses the metric from the signals to be analyzed to select the closest prior model to the current one as a baseline model. Then, the latent signal detection subunit 344 uses the baseline model for parameterization to generate a full model. In some embodiments, 50 fitness metrics can be generated from the model results. Example metrics may include Haversine metric, basic metrics on HDBScan identified clusters (e.g., min value, max value, average value, etc.), and metrics defined by t-distributed stochastic neighbor embedding (e.g., the average size of the cluster and number of overlapping clusters).

Then, the latent signal detection subunit 344 compares metrics to prior models and selects outcome performance accordingly. If the fitness metrics yield sufficient expected performance, then the latent signal detection subunit 344 exits the tuning process. Otherwise, for each parameter, the latent signal detection subunit 344 uses the XGBoost model to determine the direction to adjust each parameter and re-run the model until the tuning is completed.

In some embodiments, when new values (e.g., hourly updated news articles, stock prices, etc.), enter the system, the unsupervised model is run to look for information. For example, any shifts in generated data topology (e.g., anomalies or known patterns like holiday shopping) can be identified. In some embodiments, the latent signal detection subunit 344 may also identify a correlation with pre-identified partner targets or proxies, where a proxy is used when the data is highly similar. The latent signal detection subunit 344 may generate distance metrics to determine if the embedding space can be used to identify participant targets or proxies when combined with the participant's data. In some embodiments, new data sources (e.g., data from a sensitive source such as an article on a person or a data breach from the dark web) can be tested in isolation.

If sufficient data is available, unsupervised models can be rebuilt with new data. Accordingly, the latent signal detection subunit 344 may generate model fitness metrics. If the model does not meet fitness requirements, the latent signal detection subunit 344 can tune the model as defined by automated parameterization, generate distance metrics to determine if the embedding space can be used to identify participant targets or proxies, and then generate models to determine whether the combined signals, in addition to the data provided by the participant, can predict any participant targets or proxies. In some embodiments, all the model results and metrics may be stored for downstream use when a potential leakage is identified.

The adaptive sensitive signal modulation subunit 346 may be configured to enrich and modulate network signals, so as to obtain encapsulated pan-network signals and encapsulated participant signals respectively. Examples of the types of the data modulation may include combining exposed participant's signals, changing the summary level of the exposed participant's data, and transformation techniques such as wavelets, and fussy feature generation on exposed participant's data.

In the initialization stage, for each exposure modulation, the adaptive sensitive signal modulation subunit 346 applies the modulation rule to participant's signals most correlated with the target. Then, the adaptive sensitive signal modulation subunit 346 generates model fitness metrics. If the model does not meet fitness requirements, the adaptive sensitive signal modulation subunit 346 tunes the model as in the automated parameterization. Then, distance metrics are generated to determine if the embedding space can be used to identify participant targets or proxies. The adaptive sensitive signal modulation subunit 346 generates models to determine if combined signals, in addition to data provided by the participant, can predict any participant targets or proxies. Once sufficient signal modulation is achieved based on pre-defined metrics with the participant, then the adaptive sensitive signal modulation subunit 346 exits the modulation process. Otherwise, if the leakage exceeds the predefined threshold after the modulation, the adaptive sensitive signal modulation subunit 346 repeats the operations above, but instead of performing the modulation, the adaptive sensitive signal modulation subunit 346 removes participant signals from the shared space and tests again, until the threshold if met or the participant no longer has any signals in the shared space.

In particular, the adaptive sensitive signal modulation subunit 346 the adaptive sensitive signal modulation subunit 346 may automatically exclude sensitive signals and latent structures. For example, sensitive signals and latent structures may include information linked to sensitive or flagged data or data attributes identified by a member participant, information revealing personally identifiable information (PII), which may be any representation of information that permits the identity of an individual to whom the information applies to be reasonably inferred by either direct or indirect means. Examples of personally identifiable information include name, address, email, telephone number, date of birth, personally identifiable financial information (PIFI) and unique identifiers such as Social Security number, passport number, driver's license number, credit or debit card number, etc.

In some embodiments, other information that can be automatically identified by the platform as being unique to a specific participant, or information flagged by the platform as being erroneous or suspicious may also be classified as sensitive signals and latent structures to be excluded.

After removing the sensitive data, the adaptive sensitive signal modulation subunit 346 may provide encapsulated pan-network signals ready for the downstream processing, and encapsulated participant signals associated with participant-specific data.

For example, the APNSM unit 340 may use graph learners, data reduction techniques, semi-supervised learning, or any combination thereof, to encapsulate pan-network signals. The encapsulated pan-network signals are anonymized and in a readily usable format (e.g., numeric vectors). In some embodiments, the encapsulated pan-network signals are enriched and enhanced to specific signal classes (e.g., fraud) and checked for biases. Accordingly, participants can load data sets to pose “problems” for the platform 300 and scan the shared pan-network signal data to search for similar structures or signals that have predictive power for the posed problem.

In some embodiments, the adaptive sensitive signal modulation subunit 346 enriches and modulates network signals with external event data such as economic indicators, news events, prices, weather information, etc. For example, the pan-network data can be enriched from external data feeds to identify common structures with participants' data. In addition, the adaptive sensitive signal modulation subunit 346 may obfuscate the individual signals by mixing external data with high frequency (e.g., news data, weather data, economic data, etc.).

On the other hand, the adaptive sensitive signal modulation subunit 346 may obtain encapsulated participant signals. Thus, participants can specify data to tune their specific signals without sharing such information or signal with other participants. The participant signals are tuned to participant-specific data to guarantee individualized signals based on data contributions. Accordingly, a participant contributing a large amount of data can get optimized signals based on the contributed data and also benefit from the network. At the same time, the network also benefits from data contributed by each participant.

As shown in FIG. 3 and FIG. 4, the APNSM unit 340 may identify signals unique to a participant enabling a selective signal selection sharing based on a business case, regulatory requirements, or desired solution outcome, and then isolate participant-specific signals and linkage data from other participants. Accordingly, the APNSM unit 340 can create a signal consortium that addresses legal or business concerns of direct data sharing, improves the data and network security when providing values to large participants. In some embodiments, the signal consortium may be used to create a ready-to-deploy signal layer in various applications.

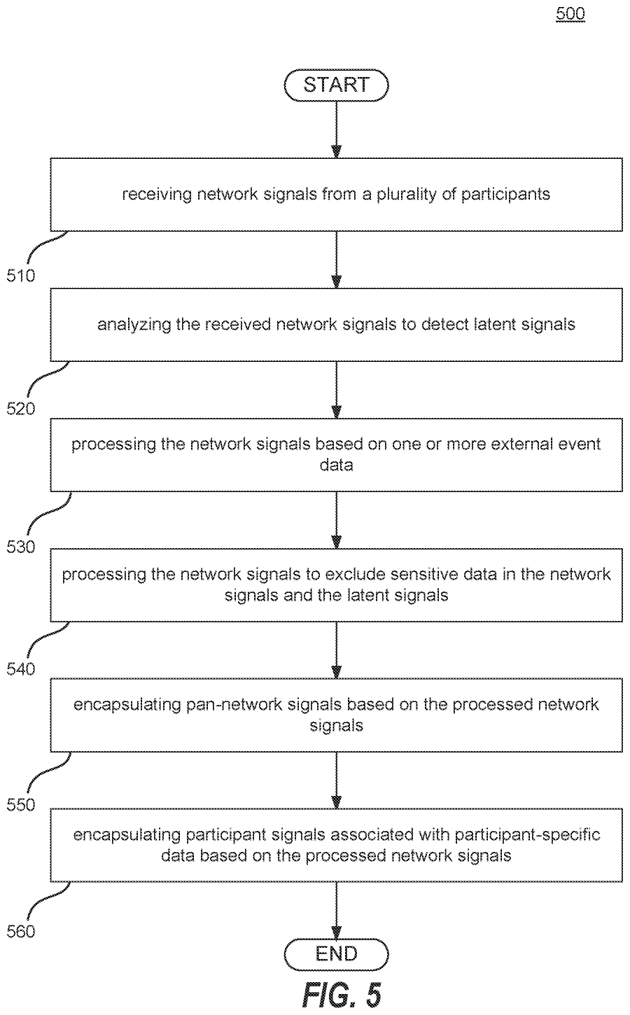

FIG. 5 is a flowchart diagram of an exemplary computer-implemented method 500 for signal modulation, consistent with some embodiments of the present disclosure. For example, the method 500 can be performed or implemented by software stored in a machine learning device or a computer system, such as the server 100 in FIG. 1 and/or the user device 200 in FIG. 2. For example, the memory 105 in the server 100 may be configured to store instructions, and the one or more processors 103 in the server 100 may be configured to execute the instructions to cause the server 100 to perform the method 500.

As shown in FIG. 5, in some embodiments, method 500 includes steps 510-560, which will be discussed in the following paragraphs.

In step 510, the APNSM receives network signals from a plurality of participants using a cloud service within a cloud environment. In some embodiments, the system may digest the raw data from different data sources by using various tools. For example, data can be first analyzed in a quality control tier to look for data outliers and anomalies, using standard tools such as principal component analysis, outlier detection for mixed-attribute dataset, and basic statistics to determine any irregularity. In some cases, network signals with significant issues can be flagged for analyst attention, and the analyst feedback for flagged features can be used if the system is not configured for full automation. On the other hand, network signals with significant issues may be excluded in a fully automated system.

In step 520, the APNSM analyzes the received network signals to detect latent signals. As discussed above, in some embodiments, the APNSM may perform a sensitive latent signal detection to detect a combination of data attributes that provides a latent signal correlated with priorly determined sensitive data.

Specifically, in the latent signal detection performed in step 520, the APNSM may use a dimensionality reduction technique, such as UMAP, to generate a new data topology. Latent structures can be identified within the new data topology, in which link events and data points are not evident from the higher-order analysis. Examples may include mentions of extreme weather linked to poor load outcomes, loan terms linked to regional articles of social justice, payment volumes summarized by the zip code linked to stock prices, aggregated user log-in behavior linked to demographics at a zip+4 code summary level that could enable identification of individuals. It is noted that the first two examples are potential examples of linkages that might not want to be exposed, and the latter two examples may be considered leakage of confidential information. Several tools and techniques can be used to surface such latent connections, such as graph community detections, HDBScan, Approximate Nearest Neighbors indexer, distance metrics (e.g., identifying a vertex X being closest to another vertex Y), and so on.

In step 530, the APNSM processes the network signals based on one or more external event data. In some embodiments, the one or more external event data may include an economic indicator data, a news event data, a pricing data, a weather data, or any combination thereof. In some embodiments, the step 530 includes receiving human-derived or interactive feedback data from one of the participants for tuning the identified network signals. In various embodiments, types of data applied in the data enrichment process of step 530 may vary depending on applications or other factors. Examples of data applied in the data enrichment process may include account history, vehicle accident records, local and national holidays, merchant network, news sentiment, daily weather conditions (e.g., temperature, humidity, wind, etc.), location data (hotels, schools, churches, etc.), daily sporting events, daily national disasters, device data (e.g., exploits), breach data from the dark web, IP address network data, aggregated personality traits studies, persona library, merchant profiles and firmographics, health data (e.g., COVID-19, flu, etc.).

In step 540, the APNSM processes the network signals to exclude sensitive data in the identified network signals and the latent signals. In some embodiments, the step 540 includes excluding signals or latent structures associated with flagged data or data attributes identified by one of the participants, signals or latent structures revealing personal identifiable information, signals or latent structures being unique to a specific participant, or erroneous or suspicious signals or latent structures.

In step 550, the APNSM encapsulates pan-network signals based on the processed network signals. In some embodiments, the step 550 includes encapsulating the pan-network signals using a graph learner model, a data reduction model, a semi-supervised learning model, or any combination thereof. For example, a sequence of graph-based data reduction and unsupervised or semi-supervised techniques may be used to generate rich metrics defining how the event relates to the event data. The data reduction and embedding process may apply various AI/ML technologies. For example, the data can be processed by a graph embedding, a graph-based dimensionality reduction, an unsupervised cluster technique or any combination thereof. Uniform Manifold Approximation and Projection (UMAP) is one example of a machine learning technique for dimension reduction.

In step 560, the APNSM encapsulates participant signals associated with participant-specific data based on the processed network signals. Thus, participants can specify data to tune their specific signals without sharing sensitive information or signal with other participants.

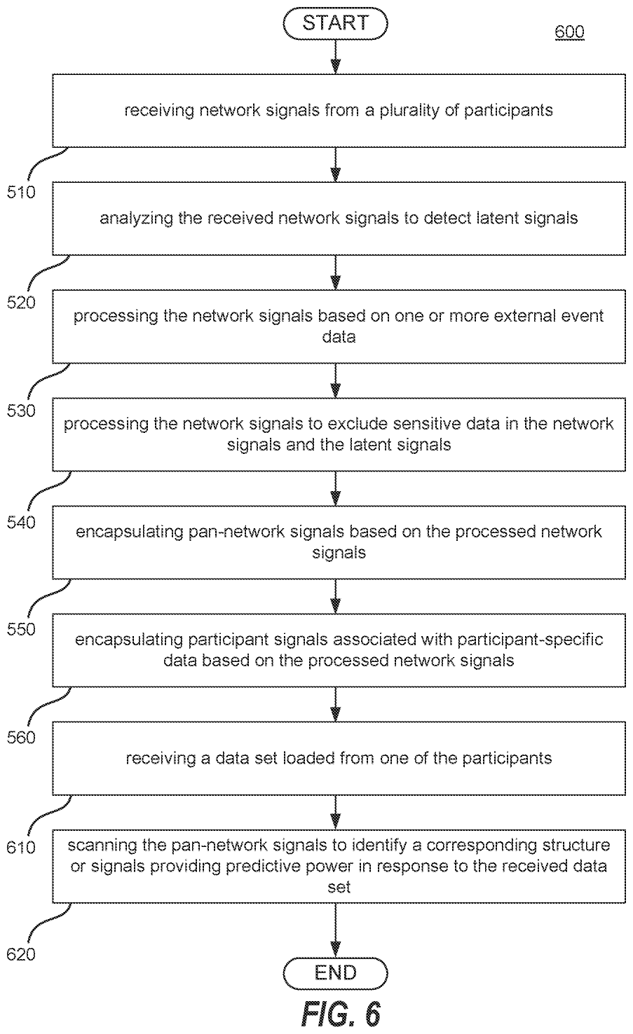

FIG. 6 is a flowchart diagram of another exemplary computer-implemented method 600 for signal modulation, consistent with some embodiments of the present disclosure. Similar to the method 500, the method 600 can be performed or implemented by software stored in a machine learning device or a computer system, such as the server 100 in FIG. 1 and/or the user device 200 in FIG. 2. For example, the memory 105 in the server 100 may be configured to store instructions, and the one or more processors 103 in the server 100 may be configured to execute the instructions to cause the server 100 to perform the method 600.

In addition to steps 510-560, the method 600 further includes steps 610 and 620. In step 610, the APNSM receives a data set loaded from one of the participants. In particular, participants can load different data sets according to actual needs to pose different problems of interest for different use cases.

In step 620, the APNSM scans the pan-network signals to identify a corresponding structure or signals providing predictive power in response to the received data set. The APNSM may also discover new signals for participants that help identify structures in data and/or have predictive powers to solve the posed problems. Using the new data topology and identified latent structures from the latent signal processing steps, the latent signals are analyzed to look at whether the correlation precedes or is prior to an event. In some embodiments, the system may presume that any latent signal that occurs past an event is a potential target. The potential targets are merged with any prior identified or added targets to create a target pool, and all other latent signals are added to the signal pool. The system can then automatically generate a supervised model predicting each target in the identified target pool using a grid search of the parameters, or some other technique of choice (e.g., random forest, neural network, etc.). Models with sufficiently predictive performance (e.g., based on metrics such as mean square error (MSE) and Area Under the ROC curve) can be promoted as potential uncovered targets, and the top features predicting the target are surfaced as signals. In some embodiments, the top features may be provided in a combined form to obfuscate the participant's data).

By the above methods 500 and 600, the APNSM is able to provide a ready-to-deploy signal layer which enables the participants to share non-sensitive information, which can improve both the network security and provide hyper-personalized experience for customers to facilitate the end-user experience.

In view of the above, by performing the method for signal modulation to remove sensitive data, the Automatic Pan-Network Signal Modulator in various embodiments of the present disclosure can address the legal, privacy, and business concerns that prevent information sharing among participants using the cloud services. The pan-network signals can be shared by participants with individually tuned feeds, and the sensitive data of each specific participant can be protected and not shared with other participants.

In some embodiments, a non-transitory computer-readable storage medium including instructions is also provided, and the instructions may be executed by one or more processors of a device, to cause the device to perform the above-described methods for event detection. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Block diagrams in the figures may illustrate the architecture, functionality, and operation of possible implementations of systems, methods, and computer hardware or software products according to various exemplary embodiments of the present disclosure. In this regard, each block in a schematic diagram may represent certain arithmetical or logical operation processing that may be implemented using hardware such as an electronic circuit. Blocks may also represent a module, segment, or portion of code that includes one or more executable instructions for implementing the specified logical functions. It should be understood that in some alternative implementations, functions indicated in a block may occur out of the order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, other embodiments of the invention will be apparent to those skilled in the art from consideration of the specification and practice of the invention disclosed herein.

The embodiments may further be described using the following clauses:

1. A method for signal modulation, comprising:
receiving network signals from a plurality of participants;
analyzing the received network signals to detect latent signals;
processing the network signals based on one or more external event data;
processing the network signals to exclude sensitive data in the network signals and the latent signals; and
encapsulating pan-network signals based on the processed network signals.
   2. The method of clause 1, further comprising:
encapsulating participant signals associated with participant-specific data based on the processed network signals.
   3. The method of clause 1, further comprising:
receiving a data set loaded from one of the participants; and
scanning the pan-network signals to identify a corresponding structure or signals providing predictive power in response to the received data set.
   4. The method of clause 1, wherein processing the network signals to exclude the sensitive data comprises:
excluding signals or latent structures associated with flagged data or data attributes identified by one of the participants, signals or latent structures revealing personal identifiable information, signals or latent structures being unique to a specific participant, or erroneous or suspicious signals or latent structures.
   5. The method of clause 1, wherein the one or more external event data comprises an economic indicator data, a news event data, a pricing data, a weather data, or any combination thereof.
   6. The method of clause 1, wherein encapsulating pan-network signals comprises:
encapsulating the pan-network signals using a graph learner model, a data reduction model, a semi-supervised learning model, or any combination thereof.
   7. The method of clause 1, further comprising:
receiving human-derived or interactive feedback data from one of the participants for tuning the network signals.
   8. A computing device, comprising:
a memory configured to store computer-executable instructions; and
one or more processors coupled to the memory and configured to execute the computer-executable instructions to perform:
receiving network signals from a plurality of participants;
analyzing the received network signals to detect latent signals;
processing the network signals based on one or more external event data;
processing the network signals to exclude sensitive data in the network signals and the latent signals; and
encapsulating pan-network signals based on the processed network signals.
   9. The computing device of clause 8, wherein the one or more processors are further configured to execute the computer-executable instructions to perform:
encapsulating participant signals associated with participant-specific data based on the processed network signals.
   10. The computing device of clause 8, wherein the one or more processors are further configured to execute the computer-executable instructions to perform:
receiving a data set loaded from one of the participants; and
scanning the pan-network signals to identify a corresponding structure or signals providing predictive power in response to the received data set.
   11. The computing device of clause 8, wherein the one or more processors are further configured to execute the computer-executable instructions to perform processing the network signals to exclude the sensitive data by:
excluding signals or latent structures associated with flagged data or data attributes identified by one of the participants, signals or latent structures revealing personal identifiable information, signals or latent structures being unique to a specific participant, or erroneous or suspicious signals or latent structures.
   12. The computing device of clause 8, wherein the one or more external event data comprises an economic indicator data, a news event data, a pricing data, a weather data, or any combination thereof.
   13. The computing device of clause 8, wherein the one or more processors are further configured to execute the computer-executable instructions to perform encapsulating pan-network signals by:
encapsulating the pan-network signals using a graph learner model, a data reduction model, a semi-supervised learning model, or any combination thereof.
   14. The computing device of clause 8, wherein the one or more processors are further configured to execute the computer-executable instructions to perform:
receiving human-derived or interactive feedback data from one of the participants for tuning the network signals.
   15. A non-transitory computer-readable storage medium storing a set of instructions that are executable by one or more processors of a device to cause the device to perform a method for signal modulation, the method comprising:
receiving network signals from a plurality of participants;
analyzing the received network signals to detect latent signals;
processing the network signals based on one or more external event data;
processing the network signals to exclude sensitive data in the network signals and the latent signals; and
encapsulating pan-network signals based on the processed network signals.
   16. The non-transitory computer-readable storage medium of clause 15, wherein the method further comprising:
encapsulating participant signals associated with participant-specific data based on the processed network signals.
   17. The non-transitory computer-readable storage medium of clause 15, wherein the method further comprising:
receiving a data set loaded from one of the participants; and
scanning the pan-network signals to identify a corresponding structure or signals providing predictive power in response to the received data set.
   18. The non-transitory computer-readable storage medium of clause 15, wherein processing the network signals to exclude the sensitive data comprises:
excluding signals or latent structures associated with flagged data or data attributes identified by one of the participants, signals or latent structures revealing personal identifiable information, signals or latent structures being unique to a specific participant, or erroneous or suspicious signals or latent structures.
   19. The non-transitory computer-readable storage medium of clause 15, wherein the one or more external event data comprises an economic indicator data, a news event data, a pricing data, a weather data, or any combination thereof.
   20. The non-transitory computer-readable storage medium of clause 15, wherein encapsulating pan-network signals comprises:
encapsulating the pan-network signals using a graph learner model, a data reduction model, a semi-supervised learning model, or any combination thereof.

What is claimed is:

1. A method for signal modulation, comprising:
receiving network signals from a plurality of participants;
analyzing the received network signals to detect latent signals;
processing the network signals based on one or more external event data;
processing the network signals to exclude sensitive data in the network signals and the latent signals; and
encapsulating pan-network signals based on the processed network signals.

2. The method of claim 1, further comprising:
encapsulating participant signals associated with participant-specific data based on the processed network signals.

3. The method of claim 1, further comprising:
receiving a data set loaded from one of the participants; and
scanning the pan-network signals to identify a corresponding structure or signals providing predictive power in response to the received data set.

4. The method of claim 1, wherein processing the network signals to exclude the sensitive data comprises:
excluding signals or latent structures associated with flagged data or data attributes identified by one of the participants, signals or latent structures revealing personal identifiable information, signals or latent structures being unique to a specific participant, or erroneous or suspicious signals or latent structures.

5. The method of claim 1, wherein the one or more external event data comprises an economic indicator data, a news event data, a pricing data, a weather data, or any combination thereof.

6. The method of claim 1, wherein encapsulating pan-network signals comprises:
encapsulating the pan-network signals using a graph learner model, a data reduction model, a semi-supervised learning model, or any combination thereof.

7. The method of claim 1, further comprising:
receiving human-derived or interactive feedback data from one of the participants for tuning the network signals.

8. A computing device, comprising:
a memory configured to store computer-executable instructions; and
one or more processors coupled to the memory and configured to execute the computer-executable instructions to perform:
receiving network signals from a plurality of participants;
analyzing the received network signals to detect latent signals;
processing the network signals based on one or more external event data;
processing the network signals to exclude sensitive data in the network signals and the latent signals; and
encapsulating pan-network signals based on the processed network signals.

9. The computing device of claim 8, wherein the one or more processors are further configured to execute the computer-executable instructions to perform:
encapsulating participant signals associated with participant-specific data based on the processed network signals.

10. The computing device of claim 8, wherein the one or more processors are further configured to execute the computer-executable instructions to perform:
receiving a data set loaded from one of the participants; and
scanning the pan-network signals to identify a corresponding structure or signals providing predictive power in response to the received data set.

11. The computing device of claim 8, wherein the one or more processors are further configured to execute the computer-executable instructions to perform processing the network signals to exclude the sensitive data by:
excluding signals or latent structures associated with flagged data or data attributes identified by one of the participants, signals or latent structures revealing personal identifiable information, signals or latent structures being unique to a specific participant, or erroneous or suspicious signals or latent structures.

12. The computing device of claim 8, wherein the one or more external event data comprises an economic indicator data, a news event data, a pricing data, a weather data, or any combination thereof.

13. The computing device of claim 8, wherein the one or more processors are further configured to execute the computer-executable instructions to perform encapsulating pan-network signals by:
encapsulating the pan-network signals using a graph learner model, a data reduction model, a semi-supervised learning model, or any combination thereof.

14. The computing device of claim 8, wherein the one or more processors are further configured to execute the computer-executable instructions to perform:
receiving human-derived or interactive feedback data from one of the participants for tuning the network signals.

15. A non-transitory computer-readable storage medium storing a set of instructions that are executable by one or more processors of a device to cause the device to perform a method for signal modulation, the method comprising:
receiving network signals from a plurality of participants,
analyzing the received network signals to detect latent signals;
processing the network signals based on one or more external event data;
processing the network signals to exclude sensitive data in the network signals and the latent signals; and
encapsulating pan-network signals based on the processed network signals.

16. The non-transitory computer-readable storage medium of claim 15, wherein the method further comprising:
encapsulating participant signals associated with participant-specific data based on the processed network signals.

17. The non-transitory computer-readable storage medium of claim 15, wherein the method further comprising:
receiving a data set loaded from one of the participants; and
scanning the pan-network signals to identify a corresponding structure or signals providing predictive power in response to the received data set.

18. The non-transitory computer-readable storage medium of claim 15, wherein
processing the network signals to exclude the sensitive data comprises:
excluding signals or latent structures associated with flagged data or data attributes identified by one of the participants, signals or latent structures revealing personal identifiable information, signals or latent structures being unique to a specific participant, or erroneous or suspicious signals or latent structures.

19. The non-transitory computer-readable storage medium of claim 15, wherein the one or more external event data comprises an economic indicator data, a news event data, a pricing data, a weather data, or any combination thereof.

20. The non-transitory computer-readable storage medium of claim 15, wherein encapsulating pan-network signals comprises:
encapsulating the pan-network signals using a graph learner model, a data reduction model, a semi-supervised learning model, or any combination thereof.
